(19) United States
(12) Patent Application Publication
(10) Pub. No.: US 2016/0375816 A1
(43) Pub. Date: Dec. 29, 2016

(54) Tonneau Tent

(71) Applicants: Edsel R. Harrison, JR., Fort Worth, TX (US); Samantha D. Harrison, Fort Worth, TX (US)

(72) Inventors: Edsel R. Harrison, JR., Fort Worth, TX (US); Samantha D. Harrison, Fort Worth, TX (US)

(21) Appl. No.: 13/686,988

(22) Filed: Nov. 28, 2012

(51) Int. Cl. B60P 3/34

(52) U.S. Cl. CPC B60P 3/341

(57) ABSTRACT

A tent enclosure for any size pickup truck and tonneau. With the tonneau in the full open position and the tailgate down, the tent encloses the sides and back of the truck bed, providing a tent sidewall enclosure with the tonneau being used as the roof and the truck bed being used as the floor. The tent attaches to the top inside surface of the tonneau using a hook and loop fastening strip encompassing the open perimeter. The bottom of the tent partially overlaps the sides of the truck and is secured with magnets. The back of the tent extends over end of the tailgate and wraps under it. Eyelets are placed along the perimeter of the bottom of the tent to be used with ties to provide additional anchorage if necessary. A door is provided in the tent for entry via the rear of the truck bed.

### RELATED APPLICATIONS

The present application is related to U.S. Pat. No. 5,335,960, issued Aug. 9, 1994, for TONNEAU/TENT SHELTER, included by reference herein.

The present application is related to U.S. Pat. No. 5,931,176, issued Aug. 3, 1999, for HINGED TONNEAU COVER TRUCK TENT, included by reference herein.

The present application is related to U.S. Pat. No. 6,030,026, issued Feb. 29, 2000, for TENT ENCLOSURE FOR TRUCK BED, included by reference herein.

### FIELD OF THE INVENTION

The present invention relates to truck tonneaus . . . and, more particularly, to hinged hard tonneaus . . .

### BACKGROUND OF THE INVENTION

Tonneaus are generally used to provide a cover for those who store and lock items and equipment in their truck bed. Trucks have been the preferred vehicle for camping for many years. However, camping in the back of a truck with a hinged hard tonneau cover has always been very difficult, if not impossible. If a person wanted to sleep or camp in the back of a truck, the typical method has always been to install a camper shell on the truck because this method allows for them to be completely enclosed and provide room for sleeping. This is not possible with the configuration of a hinged hard tonneau because when the tonneau is closed, there is no room for maneuvering due to the shallow truck bed depth, there is no air access, and many truck beds are too short for an average man to lie down comfortably. And, when a hinged hard tonneau is in the open position, a person in the truck bed is vulnerable to the outside elements and not conducive to camping or sleeping. The Tonneau Tent provides a way to sleep and camp in the back of a truck with a self supporting hinged, hard tonneau cover.

Truck tents have been created which are constructed like a standard tent with tent poles that are attached to the truck and the tent covers the open truck bed, however, this method does not work for those that have existing tonneau covers. There have also been attempts to create tonneaus with tents in one complete package, however this is expensive and once again does not serve the purpose for those who have existing tonneau covers.

Current tents for tonneaus are found to have disadvantages as following:

1. U.S. Pat. No. 5,931,176 is a combination tonneau and tent package. The tent can't be separately used with an existing tonneau cover.

2. U.S. Pat. No. 5,335,960 requires elongated support for erection. It requires a great level of difficulty and is very time consuming to install and it can not be used with an existing tonneau as the fabric becomes the tonneau.

3. U.S. Pat. No. 6,030,026 has excessive fabric that would make the tent heavy, bulky, cumbersome, and time consuming to install. It also requires additional hardware and takes a lot of room to store.

### SUMMARY OF THE INVENTION

A Tonneau Tent that is made to fit various size pickup trucks with existing self supporting, hinged hard tonneau covers. The tent material is fire retardant, tear resistant, and water repellant. The Tonneau Tent attaches to the truck with the tonneau in the full open position and the tailgate of the truck bed open. The Tonneau Tent encloses the sides and back of the truck bed, providing a tent sidewall enclosure with the tonneau cover being used as a sloped roof and the truck bed and tailgate being used as the floor. The Tonneau Tent attaches to the top inside surface of the tonneau cover using a hook and loop fastening strip encompassing the open perimeter. The bottom of the Tonneau Tent partially overlaps the sides of the truck bed and is secured with magnets that are sewn into the hem on the bottom perimeter of the tent. The front of the Tonneau Tent extends over the end of the open tailgate, wraps under it and is gathered by an elastic cord that is sewn into the hem in order to cinch the bottom of the Tonneau Tent so that it is custom fitted under the tailgate. Eyelets are placed at the bottom of the front of the Tonneau Tent so that it can also be secured to the bumper or similar device with elastic hook ties providing a taut fit for almost any truck and tonneau cover combination. Eyelets are also placed along the perimeter of the bottom of the tent sidewalls and tent side transitions of the Tonneau Tent to be used with elastic hook ties to provide additional anchorage to the truck if necessary in wind occurrences. A door is provided in the front of the tent for entry via the rear of the truck bed. There are windows on both sides of the tent for air ventilation. Both the door and the windows are made in two layers; an inner netting material to allow ventilation and the outside layer of tent material to help prevent water intrusion.

It would be advantageous to have a tent for those who have trucks with self supporting, hinged, hard tonneau covers to provide a way to camp and sleep in the bed of a truck. By utilizing the open tailgate, maximum interior volume of the Tonneau Tent is achieved. The Tonneau Tent is very compact and can be stored in the back of the truck for use in a moments notice. Because of the Tonneau Tent's simplicity of design, which includes in part; magnets, a hook and loop fastening system and an elastic cord; it is extremely quick to install and uninstall from the truck. An average adult person can generally install the Tonneau Tent in about two minutes. Because of its unique design, the Tonneau Tent is equipped to fit various size trucks with self supporting, hinged hard tonneau covers from various manufacturers.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a tonneau tent on the truck;

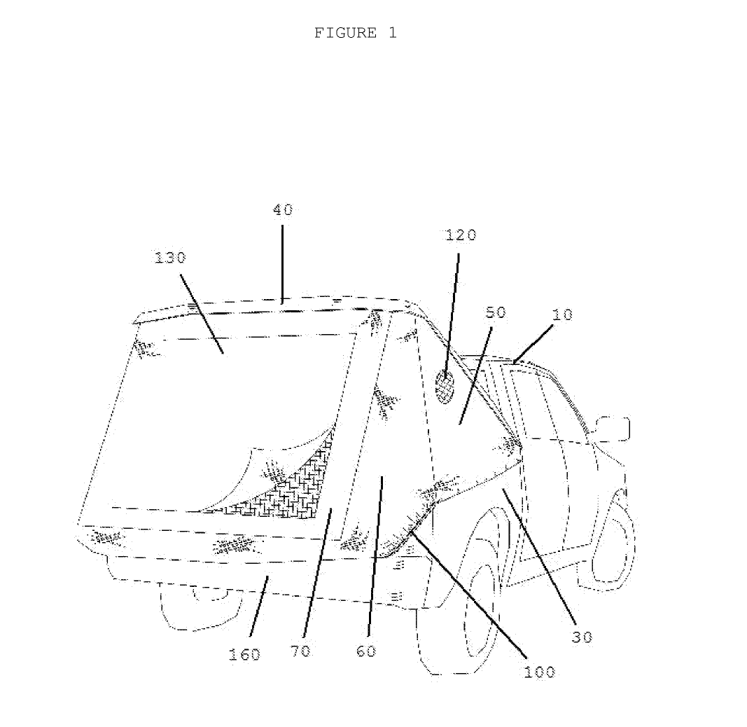

FIG. 2 is a fold out view of a tonneau tent when it is laid out and not on the truck;

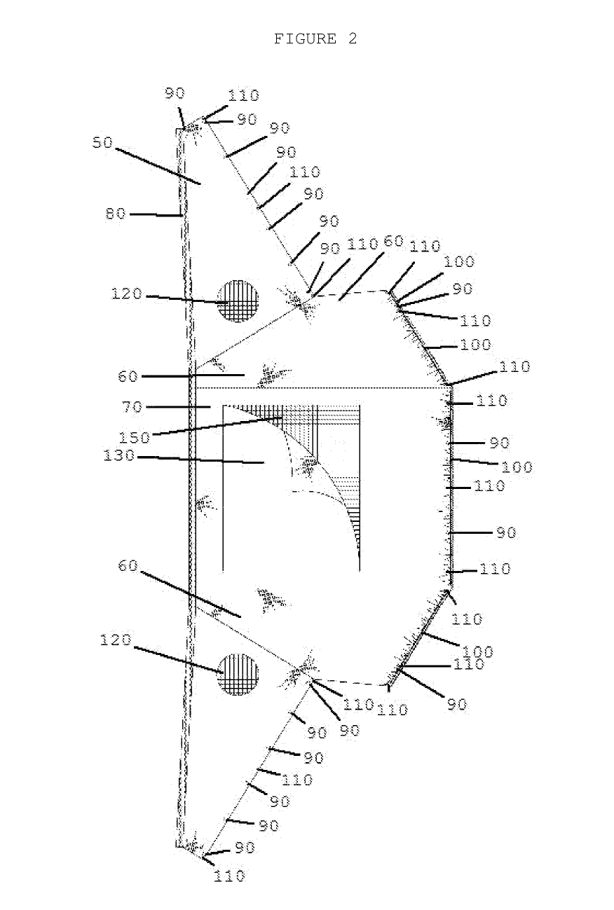

FIG. 3 is a side elevation view of a tonneau tent on the truck;

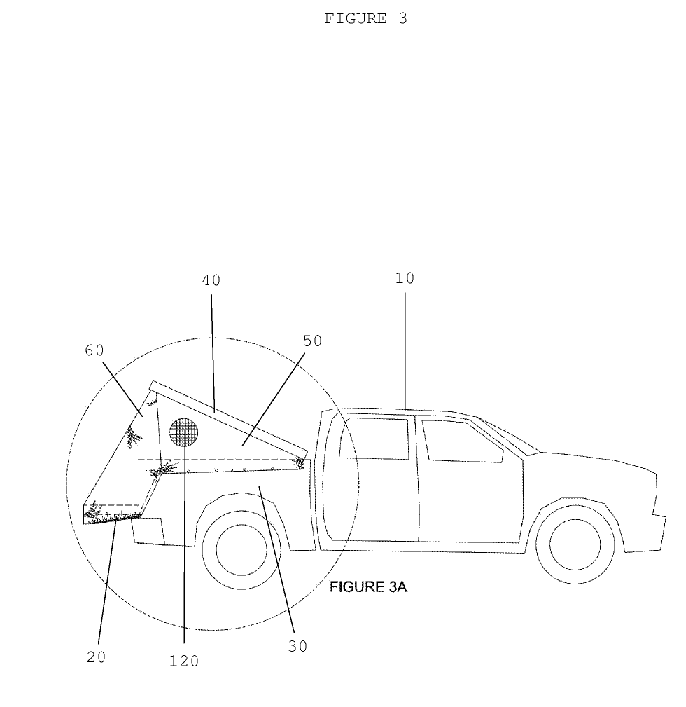

FIG. 3A is a side elevation partial view of a tonneau tent;

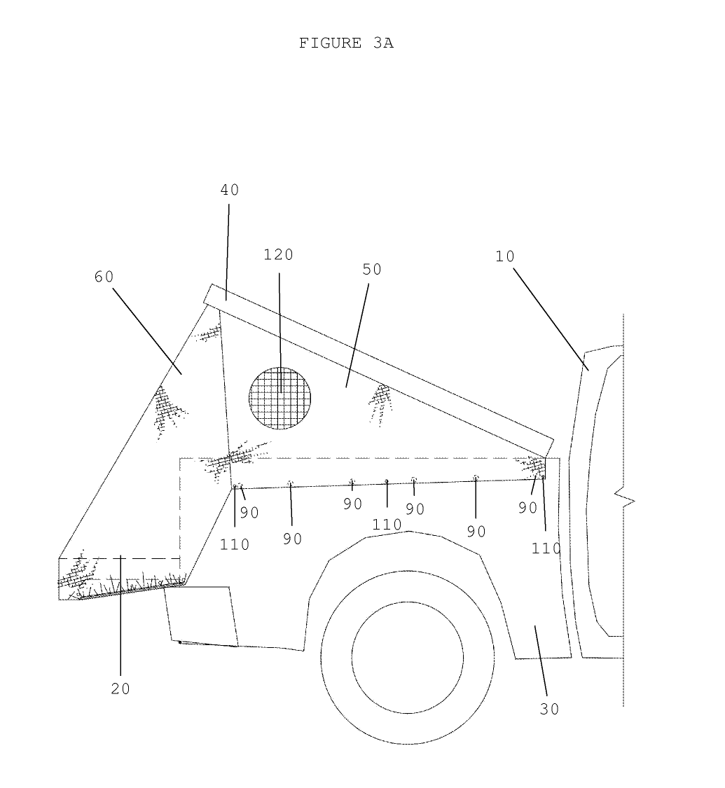

FIG. 4 is a front elevation view of a tonneau tent. this is the entrance of the tent. it is a zipper opening door that allows access into the tent;

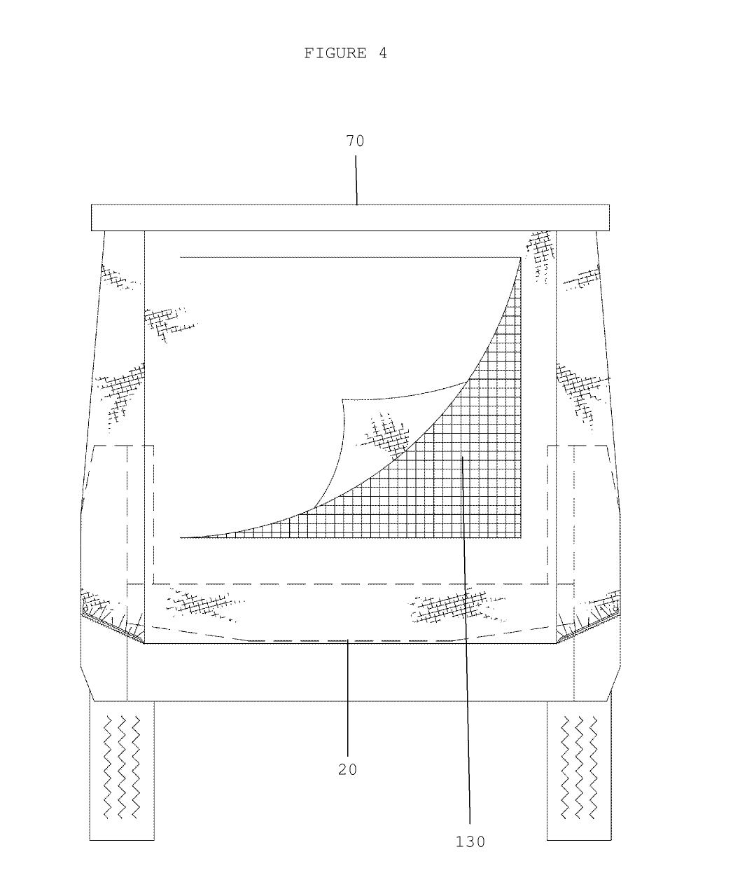

FIG. 5 is a top elevation view of a tonneau tent. it shows the hinged hard tonneau that becomes the top of the tent;

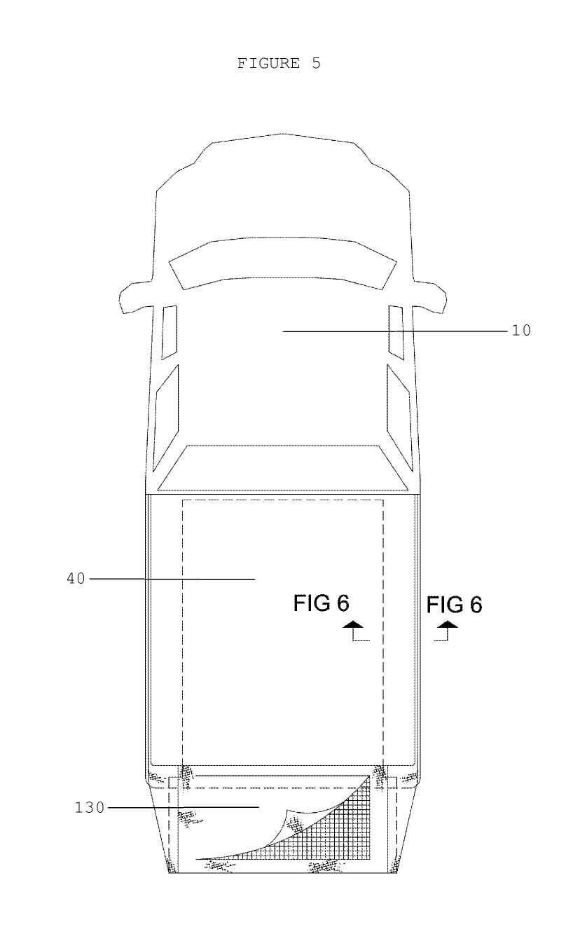

FIG. 5A is a top partial view of a tonneau tent on the truck;

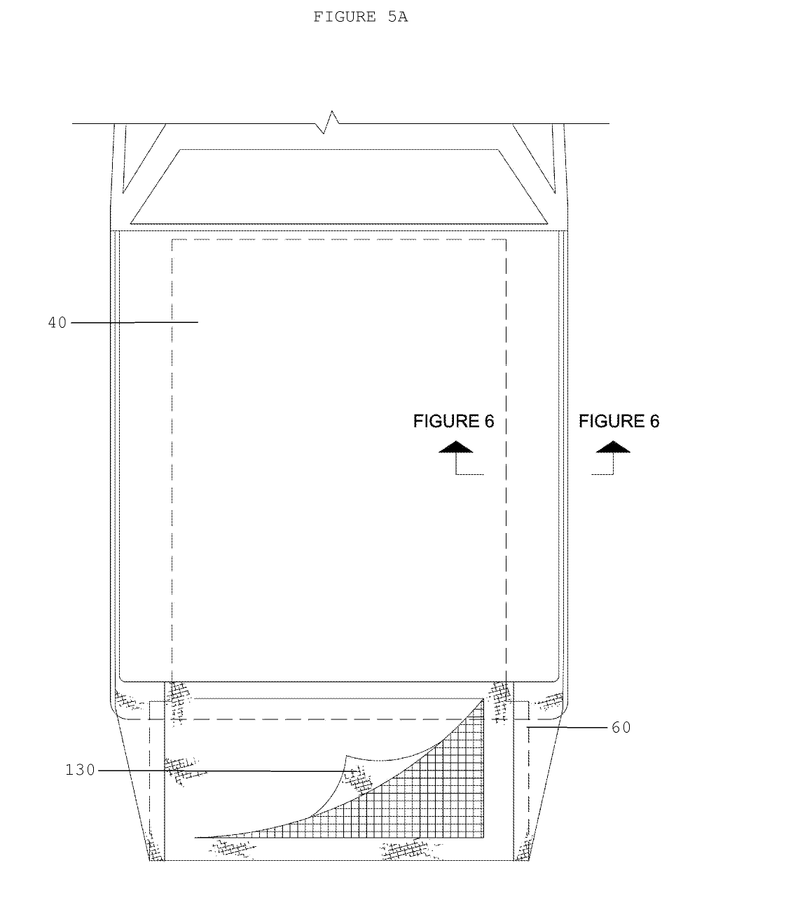

FIG. 6 is a section view of a tonneau tent and how it connects to the tonneau and to the side of the truck bed;

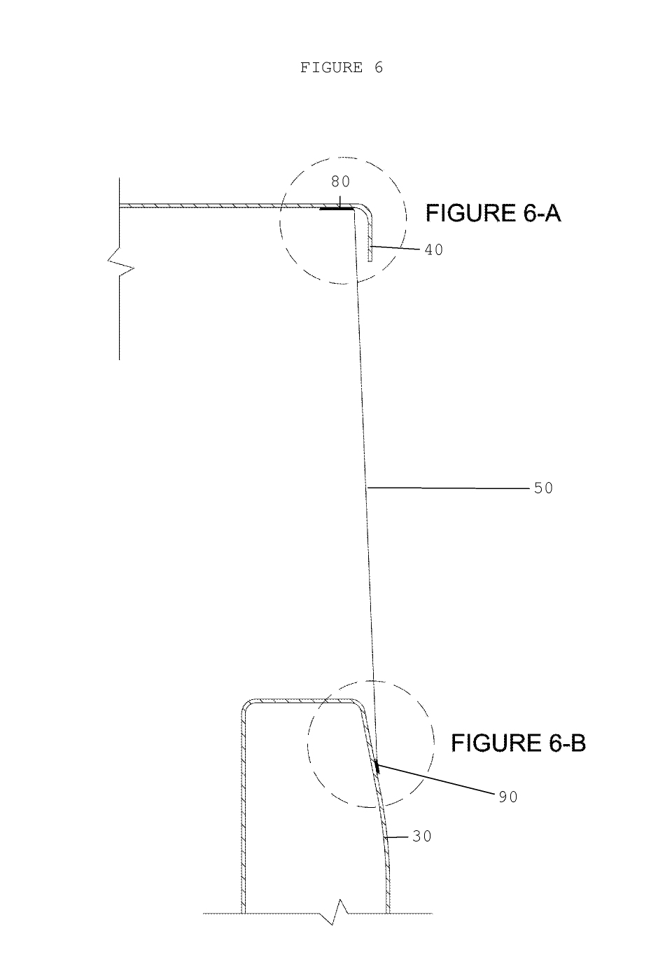

FIG. 6A is a section partial view of a hook and loop and how it is connected to the underside of the tonneau; and

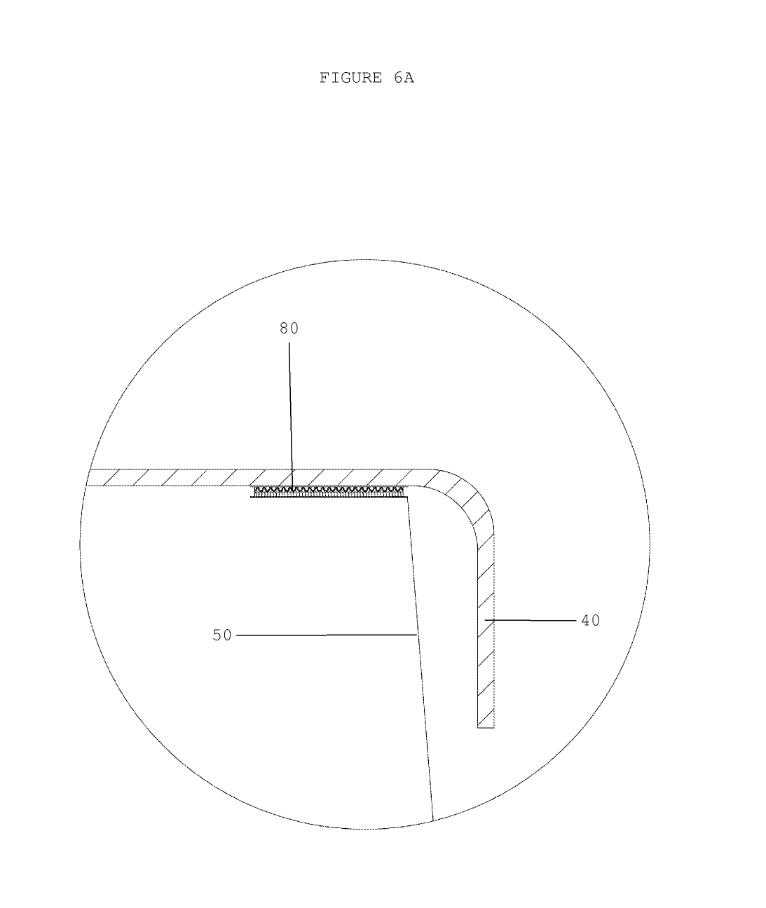

FIG. 6B is a section partial view of a tonneau tents and how it is secured to the side of the truck by magnets that are sewn into the hem of the tent.

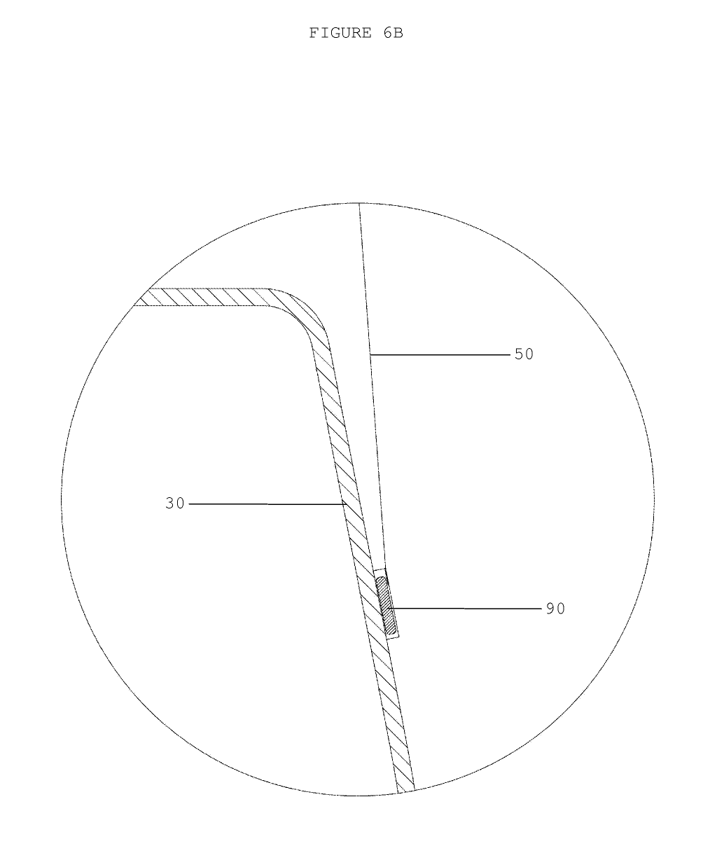

For purposes of clarity and brevity, like elements and components will bear the same designations and numbering throughout the Figures.

### DESCRIPTION OF THE PREFERRED EMBODIMENT

A tent enclosure for any size pickup truck 10 and any size hinged hard tonneau 40 that is attached to said pickup truck 10. The Tonneau 40 Tent is made of tent material that is fire retardant, tear resistant and water repellant to provide an environment that is conducive to overnight camping and one that is safe from the outside elements. The tent encloses the open sides and rear of the open tonneau 40, with the tonneau 40 being hinged at the front of the bed, and in the open position in the rear of the truck bed 30. With the tonneau 40 in the full open position and the tailgate 20 down, the Tonneau 40 Tent completely encloses the sides and back of the truck bed 30, providing a tent sidewall 50 enclosure, and a tent front 70 entrance; the tonneau 40 being used as the roof of the enclosed tent structure and the truck bed 30 being used as the floor of the enclosed tent structure.

The tent attaches to the top inside surface of the tonneau 40 using a hook and loop fastening strip 80 encompassing the open perimeter of the tonneau 40 (the sides and rear of the truck bed 30). A hook and loop fastening strip 80 is sewn into the top of the tent sidewalls, tent side transition 60 pieces and the rear wall and is used to secure the top of the tent to the inside perimeter of the tonneau 40. The bottom of the tent partially overlaps the sides of the truck 10 and is secured with magnets 90 that are sewn into the hem of the bottom of the tent. It is also equipped with eyelets and ties for extra anchorage in wind situations. The front of the Tonneau 40 Tent extends over end of the tailgate 20 and wraps under it and is secured with a tight fit by elastic 100. A zippered opening door 130 that allows access into the tent is provided via the rear of the truck bed 30. The door 130 is zippered in two layers. One that is of a mesh material that lets wind through and another layer of tent material zippered on to seal the tent and repel water. The Tonneau 40 Tent also has a window 120 on either side of it that is made the same way; two layered, one to allow air flow and one to prevent water intrusion.

Tonneau 40 covers generally come with a type of indoor/outdoor carpet lining on the underside. The hook and loop strip attaches directly to this carpet/material. In the event that a tonneau 40 is fiberglass and does not have this indoor/outdoor carpeting; another strip of sticky back hook and loop will need to be attached to the inside perimeter of the tonneau 40; then the tent will be attached directly to this hook and loop strip. The tent is made of five pieces of material that allow it to wrap around and the truck 10 and completely enclose the truck bed 30 with the tailgate 20 open and extended. The tent is kept securely on the truck 10 by magnets 90. The magnets 90 are sewn into the bottom perimeter hem of the sides of the tent. This keeps the tent weighted down, provides a taught fit and secures the tent to the truck 10. This design allows the Tonneau 40 Tent to fit all trucks with a hinged, hard tonneaus. Along the bottom perimeter of the truck 10, there are also eyelets. These eyelets are to provide additional anchoring in wind situations. There are ties that can be used to attach to the eyelet 110 and the ground or various places on the truck 10.

The Tonneau 40 Tent is lightweight and small. It can fold up smaller than a sleeping bag and can be stored in the back of the tonneau 40. The Tonneau 40 Tent attaches to the truck 10 in minutes.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

1-5. (canceled)

6. A tonneau tent for a truck having a flatbed with a tailgate and a tonneau that covers the flatbed, the tonneau tent comprising:
a front having a first end and a second end, the front being configured to extend around the tailgate;
an elastic material attached to the first end of the front, the elastic material being configured to stretch around the tailgate and detachably secure to the front to the periphery of the tailgate;
a first sidewall and a second sidewall, the first and second sidewalls being integrally attached to the front end, the first and second sidewalls each having a lower end and an upper end;
a plurality of magnets attached to the lower end of the first and second sidewalls, the plurality of magnets being configured to secure the first and second sidewalls to the flatbed; and
a plurality of hook-loop fasteners attached to the upper end of the first and second sidewalls, the hook-loop fasteners being configured to secure the upper end of the first and second sidewalls to the tonneau.
